(19) United States
(12) Patent Application Publication
(10) Pub. No.: US 2003/0144984 A1
(43) Pub. Date: Jul. 31, 2003

(54) Automatic bookmark update method and apparatus

(75) Inventor: Anthony Michael Dunbar, Rochester, MN (US)

Correspondence Address: Grant A. Johnson, IBM Corporation, Dept. 917, 3605 Highway 52 North, Rochester, MN, 55901-7829, US

(73) Assignee: International Business Machines Corporation, Armonk, NY (US)

(21) Appl. No.: 10/060,180

(22) Filed: Jan. 30, 2002

(51) Int. Cl. G06F 7/00

(52) U.S. Cl. 707/1

(57) ABSTRACT

The present invention provides a method and apparatus for providing and maintaining a set of bookmarks in a web browser. When a site maintainer moves their web site to a new URL, the maintainer of that places a bookmark update statement in the resource associated with the old URL. The bookmark update statement contains the address of the new web site location. The web browser uses this information to update the bookmarks. With this new capability, web site developers can easily ensure that their users can find the new location of the web site.

### FIELD OF THE INVENTION

The present invention generally relates to information retrieval methods in a computer network. More particularly, the present invention relates to an improved method for providing and maintaining a set of bookmarks in a browser for retrieving World Wide Web (“Web”) pages from the Internet.

### BACKGROUND

The development of the EDVAC computer system of 1948 is often cited as the beginning of the computer era. Since that time, computer systems have evolved into extremely complicated devices. Although today's computers are more sophisticated than EDVAC, the most basic requirements levied upon computer systems have not changed. Now, as in the past, a computer system's job is to access, manipulate, and store information. This fact is true regardless of the type or vintage of computer system.

One way that computer users have found to enhance their ability to access, manipulate, and store information is to interconnect their computer to a plurality of other computer systems to form a network. In this way, the collective resources available within the network may be shared among users, thus allowing each to enjoy resources that would not be economically feasible to provide individually. One such network is known as the Internet.

The World Wide Web, or simply “the Web,” is the most commonly used method of transferring data in the Internet environment. Information consumers, or “clients,” accomplish transactions with information providers, or “servers” using a set of communication protocols called the Hypertext Transfer Protocol (“HTTP”). This protocol provides a common set of rules for allowing users to access graphics, images, sound, video, and the like using a standard page description language known as the Hypertext Markup Language (“HTML”). HTML, in turn, provides basic document formatting and allows the developer to specify “links” to other servers and files.

In the Internet environment, a server's “address” on the Web is identified by a Uniform Resource Locator (“URL”) having a specific syntax for defining a network connection. Retrieval of information is generally achieved by the use of an HTML-compatible “browser”, e.g., the Netscape Navigator browser, that executes on the client machine. When the user of such a browser requests the content available at a particular URL, the browser issues a request to a naming service to map a hostname (e.g., “www.ibm.com”) in the URL to a particular network IP address at which the server is located. The naming service returns a list of one or more IP addresses (e.g., “198.81.209.2”) that can respond to the request. Using one of these IP addresses, the browser establishes a connection to a server. If the server is available, it returns a document or other object formatted according to the HTML specification.

Although web browsers are generally easy to use, many people find manual entry of the URL in the entry field of a browser to be difficult and/or burdensome. They can also find many URLs to be difficult to remember. That is, while the URL for the main web page of a major company can be relatively brief, e.g., www.ibm.com, subsidiary web pages can have very lengthy URLs written in, at least to the average user, an arcane syntax.

Recognizing the difficulties involved, web browser now allow the user to store a number of “bookmarks.” Each bookmark generally contains the URL for a favorite website in a list and a short description of the site. Conventional web browsers let the user add a page to the bookmark list through a pop-up menu on a toolbar or through a menu pulldown from the main menu bar. Thus, a user can add a bookmark for a favorite page to their bookmark list on a conventional browser by first traveling to the page and, once there, opening a bookmarks menu and choosing the “Add Bookmarks” selection. This set of actions causes the browser to store the URL of the current page as an item in the bookmarks list. Once created, the bookmarks list offers a convenient means of returning to that page. Thus, the user is not forced to enter a lengthy URL nor retrace the original tortuous route through the Internet by which they may have arrived at the Web site each time he or she wants to view the content of the web site.

Once a bookmark is added to a bookmark list, the bookmark generally becomes a permanent part of the browser. The permanence and accessibility of bookmarks have made them a valuable means for personalizing a user's Internet access through the browser. Yet despite their usefulness, the current bookmark management technology is not without its flaws. For example, the current technology requires that users manually delete the old bookmark and enter the new one each time a web page changes its address. That is, the URL for many websites changes from time to time. This change “breaks” the bookmarks corresponding to that page. In order to fix a broken bookmark, the user must first find the web site's new URL, perform a series of actions to delete the old bookmark, and perform a series of actions to create a new bookmark pointing at the new URL. This solution, however, is tedious and changes the order of the bookmarks in the bookmark list.

These problems have compounded because, as the numbers of web sites and web pages on these sites have increased dramatically over the last few years, so has the number of bookmarks that a typical web browser user maintains on his browser. It is not uncommon for users to store hundreds of bookmarks in their bookmark file after even a few weeks of web browsing.

One partial solution to this problem, described in U.S. Pat. No. 5,813,007 to Nielsen, provides a mechanism for users to subscribe to a web page and for the subscribers to be notified via email when the page changes. This system, however, requires server storage space to store all of the email addresses and substantial server processing time to send out notifications to each email address. Given the rapid expansion of the Internet, these requirements could place significant demands on the system that host busy sites. This system may also have practical difficulties because users are often reluctant to provide personal information, such as their email address, due to concerns about privacy and in a desire to avoid unsolicited emails (i.e., “spam”). Finally, many users may find this requirement to be unduly burdensome to subscribe to hundreds of web sites.

These problems and others are addressed in various embodiments of the present invention

### SUMMARY

The present invention provides a method and system for automatically updating bookmarks in a web enabling technology, such as a web browser. When a site maintainer moves their web site to a new address, the maintainer of that site places a bookmark update statement in the source code for the old address. The bookmark update statement would contain the new address for the web site location and a descriptive text code. A web browser that supports the new bookmark update capacity would, upon detecting the update statement, determine if a bookmark exists for the current location and, if it does, process the update request according to the parameters supplied and the user's preferences. With this new capability, web site developers can easily ensure that their users can find the new location of the web site.

One aspect of the present invention is a method for updating bookmarks in a web browser. One embodiment of this method comprises encoding a bookmark update code in a web page stored at an old URL and transmitting the web page to a client computer. In this embodiment, the bookmark code may comprise HTML metadata encoding a new URL code and a descriptive text code.

Another aspect of the present invention is a method for updating resource locators in a web browser, comprising receiving a resource locator selection, requesting a resource associated with the selected resource locator, detecting a bookmark update code in the resource, and, in response to the detection, automatically changing the resource locator. This embodiment may further comprise storing at least one resource locator in a bookmark list, further comprising receiving an automatic bookmark update preference selection, displaying a bookmark update confirmation dialogue box, and receiving a bookmark update confirmation selection.

Two additional aspect of the present invention are a computer program product and an information providing apparatus for providing an information file identified by an information file specification, the information providing apparatus having a network interface adapted to provide access to a network. One embodiment of the computer program product comprises a program configured to perform a method of a method for updating resource locators in a web browser, and a signal bearing media bearing the program. The program, in turn, comprises receiving a resource locator selection, requesting a resource associated with the selected resource locator, detecting a bookmark update code in the resource, and in response to the detection, automatically changing the resource locator. One embodiment of the information providing apparatus comprises a first receiver adapted to receive a resource locator selection, a first transmitter adapted to requesting a resource associated with the selected resource locator, a processor adapted to detect a bookmark update code in the resource and, in response to the detection, automatically change the resource locator.

One advantage of the present invention is that it does not require significant additional processing by the client computer. This advantage is particularly significant in devices that have processing and storage limitations, such as wireless tier 3 devices. Another advantage of the present invention is that the user does not need to make an upfront choice to dynamically update bookmarks or revisit every bookmarked page after such a decision is made. Yet another advantage of the present invention is that it does not alter the order of bookmarks in a user's list. These and other features, aspects, and advantages will become better understood with reference to the following description, appended claims, and accompanying drawings.

### BRIEF DESCRIPTION OF THE DRAWINGS

FIG. 1 shows a computer embodiment suitable for use with the present invention.

FIG. 2 illustrates a plurality of computers interconnected into a network.

FIG. 3 is a scanned image of a web page display along with a list of bookmarks.

FIG. 4 illustrates a process for updating bookmarks in accordance with the present invention.

FIG. 5 illustrates a process for updating bookmarks in accordance with the present invention.

### DETAILED DESCRIPTION

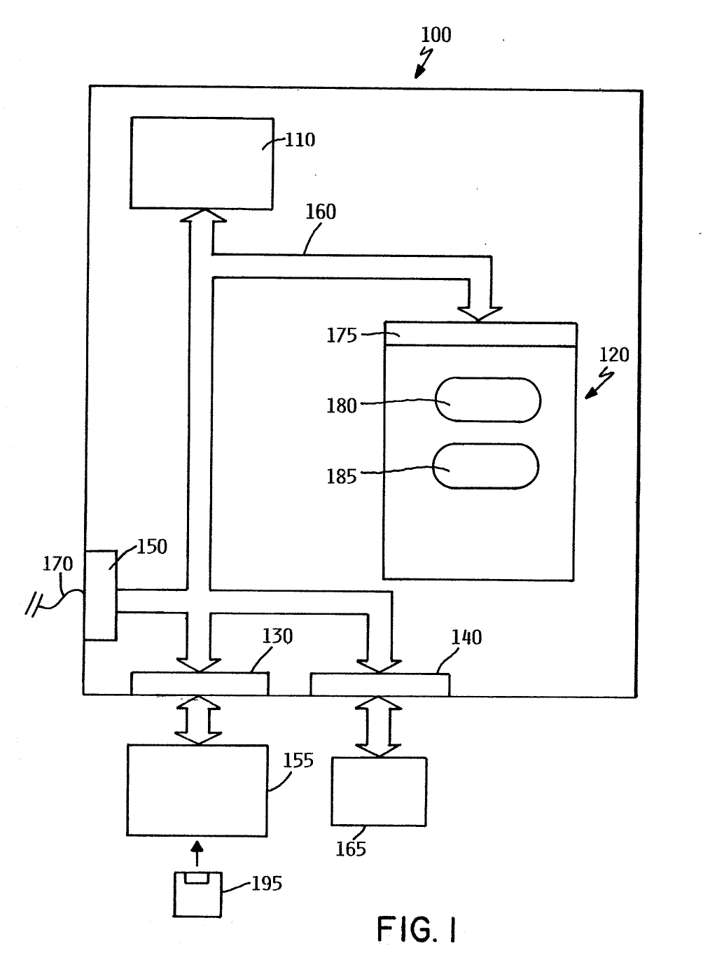

FIG. 1 depicts a computer 100 embodiment suitable for use with the present invention. This computer 100 embodiment comprises a processor 110 connected to a main memory 120, a mass storage interface 130, an I/O interface 140, and a network interface 150 via a system bus 160. The mass storage interface 130 connects one or more mass storage devices 155, such as a hard disk drive or CD-ROM drive, to the system bus 160. The input/output (“I/O”) interface 140 connects one or more input/output devices 165, such as a keyboard or cathode ray tube display, to the system bus 160. The network interface 150 connects the computer 100 to other computers 100 (not shown) over an appropriate communication medium 170, such as the Internet. The memory 120 contains one or more application programs, such as an operating system 175, a web browser program 180, and a web server program 185.

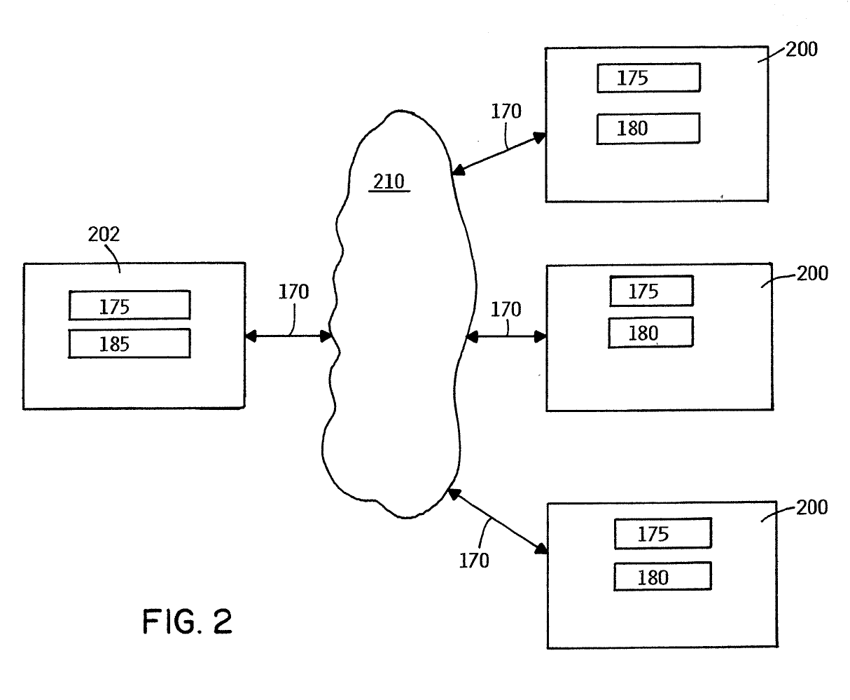

FIG. 2 illustrates a plurality of computers interconnected to implement World Wide Web processing in the Internet environment. One of the computers is configured as an information provider apparatus 202 and generally comprises a computer 100 executing a web server application 185 (referred to hereafter as a “web server”). The web server 202 provides access to information upon a request from an information access apparatus 200, which generally comprise a computer 100 executing a web browser application 180 (referred to hereafter as a “client computer”). The web server 202 and client computer 200 communicate over a communication channel 170 using an appropriate protocol, such as TCP/IP. Once the connection between the web server 202 and the client computer 200 is established, the web browser program 180 and the web server program 185 can communicate with each other using an appropriate text markup language, such as the HyperText Transfer Protocol (HTTP). Although depicted as separate computers in FIG. 2, those skilled in the art will appreciate that the web server 185 and the web browser 180 can be executing on the same computer and that the communication channel 213 between the applications need not actually be made across the network 210.

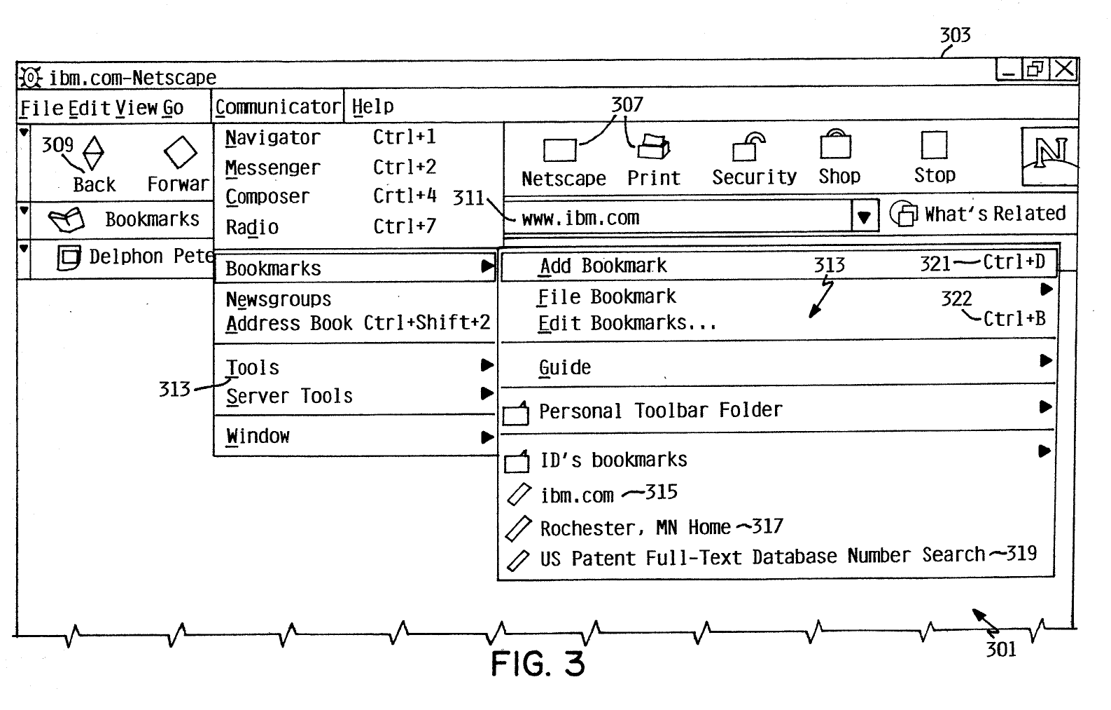

FIG. 3 illustrates a web page 301 provided by the web server 202 and viewed on the client computer 200. The web page information 301 is displayed in a window 303 by the web browser 180. This web browser program 180 provides operator command buttons 307, navigation buttons 309, and presents an address field 311 for the URL for the currently displayed Web Page 301. FIG. 3 also shows a bookmark window 313. This popup 313 displays the titles of current bookmarked web pages 315, 317, 319 along with a menu command 321 used to create a bookmark for the current page 301 and a menu command 322 to execute a bookmark management facility. Each bookmark 315, 317, 319 comprises a URL to a favorite page and an associated descriptive text string which describes the web page in such a way to be easily recognized by the user. The descriptive text can be entered by the user when creating the bookmark set and/or may default to some text provided by the web page, such as the page's title. The bookmarks 315, 317, 319 may also contain other information, such as pointers to locally cached copies of the desired web page.

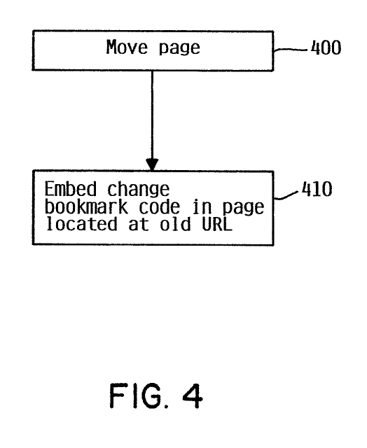

FIG. 4 depicts aspects of the present invention performed on the server computer 202. At block 400, a web site maintainer changes the URL associated with a particular web page. That is, the web site maintainer moves the web page 301 from an old URL to a new URL. At block 410, the maintainer creates a URL change notification page for storage and display at the old URL. This notification page includes an embedded “bookmark update” code, which directs compliant web browser applications 180 to automatically update any bookmark entries pointing at the old URL.

More specifically, the bookmark update code may be any computer readable code containing the URL of the new web site location. This information may encoded in any suitable manner, preferably in a manner transparent to the user of the client machine 200, such as encoding it as HTTP 4.0 metadata. Thus, for example, one appropriate bookmark code to direct a user to a website's new location at “www.newURL.org” is:

<meta HTTP-EQUIV=“REFRESH” CONTENT=“3; URL=www.newURL.org”>

where 3 is the number of seconds to wait before the browser goes to the next page and the text following the “URL=” is the location of the new page. These embodiments are desirable because this code is commonly used for web site redirection. Thus, web browsers could use this meta tag to update bookmarks in accordance with the present invention without the need for a new standard code. Another appropriate bookmark update code is:

<META HTTP-EQUIV=“Bookmark-Update” CONTENT=“URL=www.newURL.org”>

This code is desirable because optional parameters can be included in the new code standard. For example, a parameter could be added to define whether the new URL should replace the existing URL or be added to the list of saved addressed next to the existing address, or that defines a short text description of the new site. More information about HTML codes and document creation can be found in Eric Ladd et al., Platinum Edition Using XHTML, XML, and Java 2 (Que Corporation 2001), which is herein incorporated by reference.

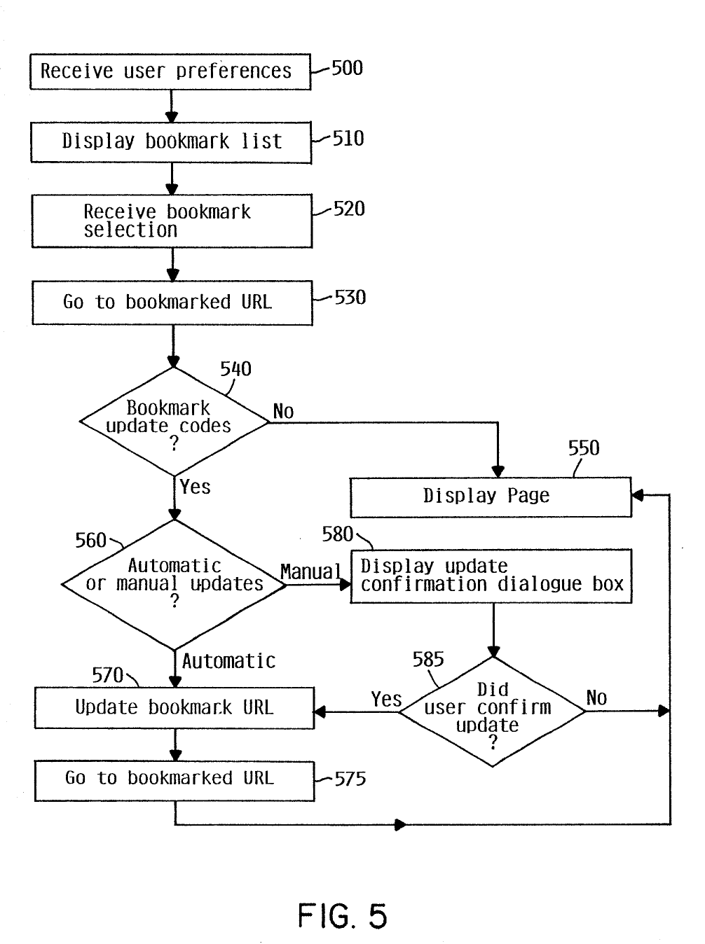

FIG. 5 depicts aspects of the present invention performed on the client computer 200. At block 500, the user starts the web browser application 180 and configures the browser 180 to accept bookmark updates. One suitable method is to allow the user to select an “automatic updates” option or a “manual confirmation” option on a preferences menu. At block 510, the user instructs the client computer 204 to display a list of bookmarked pages. The user then selects one of the bookmarked pages off the list at block 520 and instructs the web browser 180 to display that page associated with that bookmark. At block 530, the browser application 180 sends a message to the server 204 at URL associated with the selected bookmark. This message asks the server 204 to send the HTML file stored at the bookmarked URL to the client computer 200. After receiving the content, the web browser 180 parses the content at block 540 for any bookmark update codes. If the web browser 180 detects the bookmark update code, it proceeds to block 560, otherwise it displays the content normally at block 550.

At block 560, the web browser determines whether the user selected automatic update or manual update at block 500. If the user selected automatic updating, the web browser 180 updates the bookmark to the new URL at block 570. That is, the web browser 180 changes the URL to which the bookmark is linked from the current page's URL to the URL in the bookmark update code. The web browser 180 then requests the content associated with the new URL at block 575.

If the user selected the manual confirmation preference at block 500, the web browser 180 displays a popup box at block 580 informing the user that it has found an bookmark update code and displaying a control button that the user can select to confirm that this bookmark should be updated. If the user indicates that they want their bookmark updated, the browser proceeds to block 570 and processes the bookmark update as previously described. If the user indicates that they do not want their bookmark updated, the browser proceeds to block 550 and displays the content, if any, existing at the old URL.

Some embodiments of the present invention may allow the user to update bookmarks pointing to a page even if the user did not use a bookmark the to arrive at that page. In these embodiments, after detecting a bookmark update code at block 540 and before detecting the update preferences at block 560, the web browser will determine whether there are any bookmarks pointing to that URL in the user's bookmark list. If a bookmark exists, the browser will proceed to block 560, otherwise, it will proceed to block 500 and display whatever content exists at the old URL. It may be desirable in these embodiments to restrict the web browser so that only bookmark that may be changed by the bookmark update code is the one that points to the page containing the code.

Referring again to FIG. 1, the processor 110 in the computer 100 may be constructed from one or more microprocessors and/or integrated circuits. Processor 110 executes program instructions stored in main memory 120. Main memory 120 stores programs and data that the processor 110 may access. When computer 100 starts up, the processor 110 initially executes the program instructions that make up the operating system 124. The operating system 175 is a sophisticated program that manages the resources of the computer 100. Some of these resources are the processor 110, the main memory 120, the mass storage interface 130, the input/output interface 140, the network interface 150, and the system bus 160.

The I/O interface 140 directly connects the system bus 160 to one or more I/O devices 165, such as a keyboard, mouse, or cathode ray tube. Note, however, that while the I/O interface 140 is provided to support communication with one or more I/O devices 165, some computer 100 embodiments do not require an I/O device 165 because all needed interaction with other computers 100 occurs via network interface 150.

Although the computer 100 is shown to contain only a single processor 110 and a single system bus 160, those skilled in the art will appreciate that the computer 100 may have multiple processors 110 and/or multiple buses 160. In addition, the interfaces may also each include a separate, fully programmed microprocessor. These embodiments may be desirable because the interface processors can off-load compute-intensive processing from processor 110. However, those skilled in the art will appreciate that the present invention applies equally to computers 100 that simply use I/O adapters to perform similar functions.

The network interface 150 and communication medium 170 are used in this embodiment to connect other computers and/or devices to the computer 100 across a network 210. The present invention applies equally no matter how the computer 100 may be connected to other computers and/or devices, regardless of whether the network connection is made using present-day analog and/or digital techniques or via some networking mechanism of the future. In addition, many different network protocols can be used to implement the communication between the computers and/or devices. One suitable network protocol is the Transmission Control Protocol/Internet Protocol (“TCP/IP”).

The web browser program 180 may be any device that allows for viewing the content of the Internet. In this embodiment, the web browser 180 is a program that is capable of parsing and presenting documents written in the standard Internet mark language protocols, such as HTML, dynamic HTML, and XML. In the present invention, the browser 180 is equipped with a bookmark manager (i.e., a software module which handles sets of bookmarks which provide referents, typically URLs, to various locations in the Internet). The bookmark manager is preferably part of the browser itself. One suitable web browser 180 is Netscape Navigator. However, many browsers exist, some of which are general purpose and have many capabilities to provide a variety of functions, while others are designed for special purpose use.

Upon starting the web browser 180, the first page the user sees is the current “home page”. The URL of the home page can be regarded as the first bookmark in the browser. Although entry of a URL is one way of browsing the Web, the user may also traverse to another Web page by clicking highlighted words, images or graphics in a page activating an associated hyperlink to bring another page or related information to the screen. Each hyperlink contains URL location information that serves as an address of the web site. Navigational aids such as Back and Forward toolbar buttons 309 are available to proceed back or forward to pages which have been previously accessed. Other navigation aids are the bookmarks that are used in the present invention.

The web server 202 may be any system capable of accepting and responding to requests for information from the client. One suitable server is the iSeries computer running the Websphere web application server program, both available from International Business Machines. Although depicted as a single computer 100, a series of server computers 100 may be involved in the storage and distribution of a specific web page 301.

The mass storage interface 130 in this embodiment directly connects the system bus 160 to one or more mass storage devices 155. The mass storage devices 155, in turn, may be any apparatus capable of storing information on and/or retrieving information from a mass storage medium 195. Suitable mass storage devices 155 and mediums 195 include, without limitation, hard disk drives, CD-ROM disks and drives, DVD disks and drives, tapes and tape drives. Additionally, although the mass storage device 155 is shown directly connected to the system bus 160, embodiments in which the mass storage device 155 is located remote from the computer 100 are also within the scope of the present invention.

Referring again to FIG. 2, the URL or “Uniform Resource Locator” may be any code or set of parameters capable of locating resources on the network. The current definition for the Internet network is defined in RFC 1945, which is incorporated herein by reference. Under this specification, the URL is typically of the format: http://somehost/somedirectory?parameters . . . “where “somehost” is the hostname position of the URL, “somedirectory” is a directory in which the web page may be found. The usual manner in which a URL is resolved into an actual IP address for a web server is through the use of a nameserver. In an Internet or intranet network, a nameserver maps hostnames in URLs to actual network addresses. An example of a nameserver is the Domain Name Service (DNS) currently implemented in the Internet. The process of having a Web client request a hostname and address from a nameserver is sometimes called resolution. In TCP/IP, the nameserver resolves the hostname into a list of one or more IP addresses which are returned to the Web client in an HTTP request. Each IP address identifies a server which hosts the requested content made by the browser.

Although the present invention has been described in detail with reference to certain examples thereof, it may be also embodied in other specific forms without departing from the essential spirit or attributes thereof. For example, the present invention, and components thereof, are also capable of being distributed as a program product in a variety of forms, and applies equally regardless of the particular type of signal bearing media used to actually carry out the distribution. Examples of suitable signal bearing media include, without limitation: recordable type media, such as floppy disks and CD-RW disks, CD-ROM, DVD, and transmission type media, such as digital and analog communications links. In addition, although the discussion above has focused on the use of computer, HTTP, and HTML, the invention is not limited to these protocol or devices. Thus, other markup languages, such as dynamic HTML and XML, and other types of devices, such as wireless tier 3 devices, are all within the scope of the present invention.

Those skilled in the art will appreciate that the accompanying figures and this description depict and describe embodiments of the present invention, and features and components thereof. It is therefore desired that the embodiments described herein be considered in all respects as illustrative, not restrictive, and that reference be made to the appended claims for determining the scope of the invention.

I claim:

1. A method for updating bookmarks in a web browser, comprising:
encoding a bookmark update code in a web page stored at an old URL; and
transmitting the web page to a client computer.

2. The method of claim 1, wherein the bookmark code comprises a new URL code.

3. The method of claim 2, wherein the bookmark comprises a descriptive text code.

4. The method of claim 2, wherein the bookmark update code comprises HTML metadata.

5. A method for updating resource locators in a web browser, comprising:
receiving a resource locator selection;
requesting a resource associated with the selected resource locator;
detecting a bookmark update code in the resource; and
in response to the detection, automatically changing the resource locator.

6. The method of claim 5, wherein the resource locator comprises web page bookmark.

7. The method of claim 6, wherein the bookmark comprises a URL at which the resource is located and a text description of the resource.

8. The method of claim 5, wherein the content comprises a set of hypertext markup language instructions.

9. The method of claim 8, wherein the update code comprises an HTML metadata tag.

10. The method of claim 5, further comprising storing at least one resource locator in a bookmark list.

11. The method of claim 5, further comprising receiving an automatic bookmark update preference selection.

12. The method of claim 5, further comprising:
displaying a bookmark update confirmation dialogue box; and
receiving a bookmark update confirmation selection.

13. A computer program product, comprising:
(a) a program configured to perform a method of a method for updating resource locators in a web browser, comprising:
receiving a resource locator selection;
requesting a resource associated with the selected resource locator;
detecting a bookmark update code in the resource;
in response to the detection, automatically changing the resource locator; and
(b) a signal bearing media bearing the program.

14. An information providing apparatus for providing an information file identified by an information file specification, the information providing apparatus having a network interface adapted to provide access to a network, the information providing apparatus comprising:
a first receiver adapted to receive a resource locator selection;
a first transmitter adapted to requesting a resource associated with the selected resource locator;
a processor adapted to detect a bookmark update code in the resource and, in response to the detection, automatically changing the resource locator.

15. The information providing apparatus of claim 14, further comprising a memory for storing at least one resource locator in a bookmark list.

16. The information providing apparatus of claim 14, further comprising a second receiver adapted to receive an automatic bookmark update preference selection.

17. The information providing apparatus of claim 14, further comprising:
a bookmark update confirmation dialogue box display; and
a second receiver adapted to receive a bookmark update confirmation selection.

18. A method for bookmarks in a web browser, comprising:
(a) displaying a list of bookmarks to a user;
(b) receiving a desired bookmark selection from the user, wherein the desired bookmark is associated with an old URL
(c) requesting a resource associated with old URL;
(d) detecting a bookmark update code in the resource associated with the old URL, the bookmark update code comprising a HTML metadata tag for a new URL;
(e) in response to the detection:
(1) displaying a bookmark update confirmation dialogue box;
(2) receiving a bookmark update confirmation selection;
(3) associating the desired bookmark with the new URL; and
(4) requesting a resource associated with the new URL.
